(19) United States
(12) Patent Application Publication
(10) Pub. No.: US 2006/0124011 A1
(43) Pub. Date: Jun. 15, 2006

(54) Protective agent for print with water-based ink

(76) Inventors: Tetsuo Kijima, Tokyo (JP); Tetsuya Ochiai, Kanagawa (JP); Hisako Kobayashi, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/525,017

(22) PCT Filed: Aug. 20, 2002
(86) PCT No.: PCT/JP02/08384

§ 371 Date: Oct. 18, 2005

(51) Int. Cl. B41F 23/04

(52) U.S. Cl. 101/416.1

(57) ABSTRACT

A protective agent for printed matters obtained by printing with water-based inks. It comprises: at least 50% low-boiling hydrocarbon solvent based on all solvents and an oleophilic resin soluble therein. The proportion of the low-boiling hydrocarbon solvent to the oleophilic resin is from 97/3 to 40/60 by weight. The low-boiling hydrocarbon solvent has a boiling point of 50 to 110° C. Example of the low-boiling hydrocarbon solvent include pentane, hexane, heptane, octane, and hexamethylsiloxane. Example of the oleophilic resin include acrylic ester copolymer resins, silicone-acrylic resins, methyl phenyl silicone resins, and 1,2-polybutadiene elastomers.

### TECHNICAL FIELD

The present invention relates to agents for protecting printed matters such as characters, figurers, images and the like obtained by printing with water-based inks, and more specifically to a protective agent for printed matters obtained by printing with water-based inks, capable of protecting inkjet-printed matters from deterioration caused by e.g., moisture, ultraviolet rays, ozone, oxygen, SOₓ and NOₓ for a prolonged period, while giving gloss to the printed matters and effectively avoiding occurrence of abraded wounds on the surface.

### BACKGROUND ART

As a method for protecting printed matters printed with water-based inks, especially for protecting a printed surface obtained by inkjet printing method, for example, a laminate method wherein a printed surface is covered with a transparent film (Japanese Patent Application Laid-Open Publication No. 9-66683), and a method using a water-absorptive resin (Japanese Patent Application Laid-Open Publication No. 9-76653) have been conventionally known.

One example of currently available protective agents for printed matters is an aerosol agent prepared by dissolving a multi-purpose resin such as acrylic resin solved in a solvent such as xylene.

However, among the above-described conventional techniques, the laminate method is expensive and troublesome.

Also the method using a water-absorptive resin confronts the problem that water and a water-soluble organic solvent used as a solvent dissolve dye inks to cause color drift and change in the printed state.

Although a commercially-available protective agent is easy to handle because of its aerosol form, the solvent used therein per se is highly toxic and emits heavy odor. Additionally, because of the high boiling point (144° C.), the time required for drying is long and it is difficult to form a uniform protective coating.

As a printer that prints characters or images out putted from a computer or the like, inkjet-type printers are widely used. These printers use dye inks or pigment inks, both of which are water-based inks using water as a solvent or a dispersion medium. Dye ink is prepared by dissolving a dye in water and pigment ink is prepared by dispersing a pigment in water. These inks have the following drawbacks.

1. Dye Inks

Dye per se will deteriorate and fade away under natural environment such as ultraviolet rays.

Since dye per se is water soluble, the ink is inferior in water resistance (for example, the dye will liquate out in water to cause color blurring).

2. Pigment Inks

Pigment will fall off and peel due to friction (rubbing) (inferior in abrasion resistance).

Due to adhesion defect to a printing medium such as paper, surface crack (defect portion) can occur in a printed matter such as image.

### DISCLOSURE OF THE INVENTION

The present invention was devised in consideration of the above problems, and it is an object of the present invention to provide a protective agent for printed matters printed with water-based ink, the protective agent being capable of preventing printed matters printed with water-based ink, especially in the inkjet printing method from deteriorating through color change or color degradation due to moisture, ultraviolet rays and the like various environmental factors, while affording the printed matters gloss and effectively and readily preventing abraded wounds from occurring on the surface.

In addition, the protective agent for printed matters printed with water-based ink of the present invention also overcomes the drawbacks essentially accompanying the aforementioned kinds of inks.

As a result of diligent efforts for achieving the above objects, the present inventors found that it is possible to form a protective film in a simple manner in short time without causing dissolution and elution of dyes or pigments by using a combination of specific low-boiling hydrocarbon solvent and oleophilic resin, and accomplished the present invention.

Specifically, a protective agent for printed matters printed with water-based ink of the present invention is a protective agent for printed matters printed with water-based ink which comprises at least 50% low-boiling hydrocarbon solvent based on all solvents and an oleophilic resin soluble therein.

In a preferred aspect of the protective agent for printed matters printed with water-based ink of the present invention, the proportion of the low-boiling hydrocarbon solvent to the oleophilic resin is from 97/3 to 40/60 by weight.

In another preferred aspect of the protective agent for printed matters printed with water-based ink of the present invention, the low-boiling hydrocarbon solvent has a boiling point of 50 to 110° C.

In this case, it is preferred that the low-boiling hydrocarbon solvent is at least one kind of solvent selected from the group consisting of n-pentane, i-pentane, cyclopentane, n-hexane, i-hexane, cyclohexane, methylcyclohexane, n-heptane, i-heptane, n-octane, i-octane and hexamethylsiloxane.

In other preferred aspect of the protective agent for printed matters printed with water-based ink of the present invention, the oleophilic resin is at least one kind of resin selected from the group consisting of acrylic ester copolymer resins, silicone-acrylic resins, methyl phenyl silicone resins, 1,2-polybutadiene elastomers, polyisobutylene rubbers, aromatic petroleum resins, alicyclic petroleum resins and polystyrene resins.

Furthermore, a protective aerosol agent for printed matters printed with water-based ink of the present invention comprises 20 to 80 parts by weight of the protective agent for printed matters printed with water-based ink as described above and 80 to 20 parts by weight of a propellant.

### BEST MODE FOR CARRYING OUT THE INVENTION

Now, the protective agent for printed matters printed with water-based ink of the present invention will be explained in detail. In the present description, “%” means mass percentage unless otherwise defined.

As described above, the protective agent for printed matters printed with water-based ink of the present invention includes at least 50% low-boiling hydrocarbon solvent based on all solvents and an oleophilic resin. The oleophilic resin is soluble in the low-boiling hydrocarbon solvent.

Also it is an essential feature of the present invention to form a protective film by covering printed matters with the oleophilic resin dissolved in a specific low-boiling hydrocarbon solvent.

As the low-boiling point hydrocarbon solvent, those having a boiling point of 50 to 100° C. but not limited to, are preferably used from the view point of operatability at room temperature.

If the boiling point is less than 50° C., it becomes difficult to form a uniform film of the protective agent for printed matters of the invention because it gets into a substantially dry state immediately after the treatment and recesses and projections of the printing medium is liable to be transferred. If the boiling point is more than 110° C., the time required for drying is prolonged, and it becomes difficult to form a uniform film due to, for example, inclination of the printing medium.

In the present invention, it is more preferable to use a solvent that will not let water-soluble ink blur or that will not dissolve or elute the dye, as well as having high boiling point as described above.

Concrete examples of the low-boiling hydrocarbon solvent include n-pentane, i-pentane, cyclopentane, n-hexane, i-hexane, cyclohexane, methylcyclohexane, n-heptane, i-heptane, n-octane, i-octane or hexamethylsiloxane, and any mixed solvent composed of any combination of these solvents.

On the other hand, preferred oleophilic resins will turn transparent after drying and are able to cover and protect printed matters, and are soluble in the above low-boiling hydrocarbon solvent and easy to form a uniform film. Concrete examples of such resin include acrylic ester copolymer resins, silicone-acrylic resins, methyl phenyl silicone resins, 1,2-polybutadiene elastomers, polyisobutylene rubbers, aromatic petroleum resins, alicyclic petroleum resins, polystyrene resins and any mixed resin composed of any combinations of these resins.

In the present invention, the proportion of the low-boiling hydrocarbon solvent to the oleophilic resin is representatively from 97/3 to 40/60 by weight, however, the resin occupies suitably 3 to 50%, and preferably 4 to 45%.

If the rate of resin is less than 3%, the amount of resin is too small to uniformly form a film having a suitable film thickness. If the rate of resin is more than 60%, the leveling property deteriorates, making it difficult to form a uniform film.

In order to overcome the problems of dissolution and elution of dyes of printed matters printed with dye inks, the rate of the low-boiling hydrocarbon solvent based on all solvents is set to at least 50%. The dyes may dissolve or elute when organic solvents that will influence on other dye inks, for example, alcohols (such as isopropyl alcohol), ketones (such as methylethylketone) or esters are contained at a rate of 50% or more.

On a printed surface of gloss photo paper (product name: HG-201), a genuine product of CANON printed with genuine dye ink using a printer device available from EPSON (product name: PM-900c), a mixture of a low-boiling hydrocarbon solvent and an organic solvent was sprayed, and the paper was vertically placed, and blurring of the ink was observed. The present inventors have found that blurring of ink occurs when the rate of the low-boiling hydrocarbon is less than 50%.

In the protective agent for printed matters of the present invention, it is possible to regulate the drying speed by varying the kind and mixing rate of the low-boiling hydrocarbon solvent. Specifically, the larger the amount of low-boiling components, the faster the drying speed, and the larger the amount of high-boiling components, the slower the drying speed.

The regulation of the drying speed will also influence on the surface condition of the resultant protective film in such a manner that the uniformity improves as the drying speed increases, and the gloss improves as the drying speed decreases. Therefore, the combination and proportion are important factors in formation of a protective film that protects printed matters.

In the protective agent for printed matters of the present invention, examples of suitable combination and mixing proportion of low-boiling hydrocarbon solvent and oleophilic resin include: 80 to 97% of isohexane and 20 to 3% of methylphenyl silicone resin; and 70 to 90% of isopentane and 30 to 10% of silicone-acrylic resin.

As described above, the protective agent for printed matters printed with water-based ink of the present invention essentially includes the above low-boiling hydrocarbon solvent and oleophilic resin, however, other components such as ultraviolet absorber, fluorescent brightening agent, leveling agent, flavoring agent and the like may be added.

Examples of the ultraviolet absorber include salicylic, benzotriazole and benzophenone UV absorbers, and examples of the leveling agent include alkylene oxide modified silicones and epoxy modified silicones.

There is no particular limitation on a production method of the protective agent for printed matters printed with water-based ink of the present invention insofar as the oleophilic resin uniformly dissolves in all solvents including the low-boiling hydrocarbon solvent and the formed protective film is transparent in its final state.

It may be used in any manner without particular limitation, including representative examples of spraying using an aerosol and an atomizer, and application using a brush and an applicator.

When preparing an aerosol, it is desired that 80 to 20 parts by weight of spraying agent, such as propane, n-butane or i-butane and their mixed LPG (typically at a pressure of about 0.20 to 0.55 NPa at 20° C.) or DME (dimethylether) is added, per 20 to 80 parts by weight of protective agent for printed matters printed with water-based ink of the present invention. As a result, it is possible to realize excellent leveling ability after spraying.

The transparent protective film thus formed using the protective agent for printed matters printed with water-based ink of the present invention as described above has the following characteristics and exerts a protective function for printed matters.

1. Transparent and exert no influence on tone. Improve gloss.

2. Because of excellent water resistance owing to hydrophobic property of resin itself (due to solubility in hydrocarbon solvent), moisture is kept away and water resistance improves.

3. Since the film is formed on the entire surface, oxygen, ozone, SOx and NOx and the like in the air will not directly contact with the dye, and deterioration (color degradation) caused by such contact is prevented.

4. Pigments will not fall of due to friction (rubbing).

5. Protective film with little odor can be formed in a simple manner in short time.

6. Applicable to various kinds of printing media.

### EXAMPLES

Next, the present invention will be explained in more detail by way of Examples and Comparative examples. However, the present invention are not limited to these examples.

### Examples 1 to 5

A protective agent for printed matters printed with water-based ink according to each example was produced by mixing an oleophilic resin, a low-boiling hydrocarbon solvent and other solvent listed in Table 1 at a predetermined proportion. Values in Table 1 are represented in mass percentage.

### Comparative Examples 1 to 3

Using resins and solvents listed in Table 1, similar operations to those of Examples 1 to 5 were repeated to obtain a protective agent for printed matters printed with water-based ink of each example.

TABLE 1

| | |
|---|---|
| Example | Comparative example |

| | 1 | 2 | 3 | 4 | 5 | 1 | 2 | 3 |
|---|---|---|---|---|---|---|---|---|
| Oleophilic resin | | | | | | | | |
| Silicone-acrylic resin | 6 | 20 | | | 40 | 2.5 | 15 | |
| Methyl phenyl silicone resin | | | 5 | 10 | | | | 23 |
| 1,2-polybutadiene elastomer | | | 0.5 | | | | | |
| Alicyclic petroleum resin | | | | 1.0 | | | | |
| Low-boiling solvent | | | | | | | | |
| i-hexane | 36 | 30 | 20 | | 20 | 30 | | |
| Cyclohexane | 50 | 35 | 40 | 49.0 | | 50 | 30 | 27 |
| Methylcyclohexane | 10 | 5 | 29.5 | 40.0 | 20 | | | |
| i-octane | | | 5 | | | | | |
| Other solvent | | | | | | | | |
| Isopropyl alcohol | 4 | 10 | | | 20 | 10 | 55 | |
| Dodecane | | | | | | | | 50 |
| Applying method | Aerosol | Aerosol | Atomizer | Aerosol | Applicator | Aerosol | Aerosol | Applicator |

[Performance Evaluation]

Using dye ink (EPSON, product name: PM-900C) or pigment ink (EPSON, product name: MC-2000) as water-based ink, printing was conducted on a oto gloss film (product name: HG-201) of CANON serving as a printing medium using an inkjet multi-purpose printer.

To the resultant printed matter, protective agents for printed matters printed with water-based ink of each example were applied by the respective methods listed in Table 1 to obtain samples of each example, which were subjected to the following performance evaluations.

1. Visual Observation

After applying a protective agent for printed matters, transparency, uniformity, blurring of dye, gloss and the like were observed by eyes.

2. Weather Resistance

Using a fade meter, each sample was irradiated with xenon lamp for 72 hours, and a rate of color degradation was calculated by rate of change of Optical Density value. The obtained results are shown in Table 2 separately for yellow, magenta, cyan and black. In Table 2, values regarding weather resistance are represented by “%”.

Rate of color degradation (%)=(Optical Density value after irradiation)/(Optical Density value before irradiation)×100

3. Water Resistance

Contact angel of a water droplet on the surface of each sample was measured, and obtained results are shown in Table 2. In Table 2, values regarding water resistance are represented by “∘”

TABLE 2

| | | No | | | | | | | | | | | |
|---|---|---|---|---|---|---|---|---|---|---|---|---|---|
| | | Untreated | | Example 1 | | Example 2 | | Example 3 | | Example 4 | | Example 5 | |
| Items | | Dye | Pigment | Dye | Pigment | Dye | Pigment | Dye | Pigment | Dye | Pigment | Dye | Pigment |
| Weather | Yellow | 62 | 98 | 88 | 97 | 87 | 97 | 90 | 96 | 88 | 97 | 90 | 98 |
| resistance | Magenta | 57 | 99 | 90 | 98 | 92 | 98 | 92 | 98 | 89 | 96 | 91 | 97 |
| | Cyan | 60 | 97 | 87 | 95 | 89 | 99 | 91 | 99 | 92 | 95 | 89 | 95 |
| | Black | 65 | 98 | 90 | 92 | 90 | 98 | 89 | 95 | 90 | 92 | 88 | 96 |

| | | | | | | | | | | | | |
|---|---|---|---|---|---|---|---|---|---|---|---|---|
| Water resistance | 50> | 50> | 92 | 90 | 89 | 90 | 87 | 89 | 93 | 91 | 92 | 94 |

Values for weather resistance represented by “%”
Values for water resistance represented by “°”

As can be seen in Table 2, in Examples 1 to 5 pertaining to the scope of the present invention, excellent weather resistance and water resistance are exerted. At present, Example 2 is most preferable from the view point of gloss and uniformity.

As to the visual observation, Examples 1 to 5 were excellent in transparency, uniformity and blurring of dyes and gloss. In contrast to this, in Comparative example, uniformity was inadequate due to excess spraying. In Comparative example 2, blurring occurred in a printing member of dye ink, and in Comparative example 3, drying was slow and uniformity was poor.

### INDUSTRIAL APPLICABILITY

As described above, according to the present invention, since specific low-boiling hydrocarbon solvent and oleophilic resin are used in combination, it is possible provide a protective agent for printed matters printed with water-based ink capable of preventing printed matters printed with water-based ink, especially in the inkjet printing method from deteriorating through color change or color degradation due to moisture, ultraviolet rays and the like various environmental factors, while affording the printed matters gloss and effectively and readily preventing abraded wounds from occurring on the surface.

1. A protective agent for printed matters printed with water-based ink comprising: at least 50% low-boiling hydrocarbon solvent based on all solvents and an oleophilic resin soluble therein.

2. The protective agent for printed matters printed with water-based ink according to claim 1, wherein the proportion of the low-boiling hydrocarbon solvent to the oleophilic resin is from 97/3 to 40/60 by weight.

3. The protective agent for printed matters printed with water-based ink according to claim 1, wherein the low-boiling hydrocarbon solvent has a boiling point of 50 to 110° C.

4. The protective agent for printed matters printed with water-based ink according to claim 1, wherein the low-boiling hydrocarbon solvent is at least one kind of solvent selected from the group consisting of n-pentane, i-pentane, cyclopentane, n-hexane, i-hexane, cyclohexane, methylcyclohexane, n-heptane, i-heptane, n-octane, i-octane and hexamethylsiloxane.

5. The protective agent for printed matters printed with water-based ink according to claim 1, wherein the oleophilic resin is at least one kind of resin selected from the group consisting of acrylic ester copolymer resins, silicone-acrylic resins, methyl phenyl silicone resins, 1,2-polybutadiene elastomers, polyisobutylene rubbers, aromatic petroleum resins, alicyclic petroleum resins and polystyrene resins.

6. A protective aerosol agent for printed matters printed with water-based ink comprising: 20 to 80 parts by weight of the protective agent for printed matters printed with water-based ink as set forth in claim 1 and 80 to 20 parts by weight of a propellant.

7. The protective agent for printed matters printed with water-based ink according to claim 2, wherein the low-boiling hydrocarbon solvent has a boiling point of 50 to 110° C.

8. The protective agent for printed matters printed with water-based ink according to claim 2, wherein the low-boiling hydrocarbon solvent is at least one kind of solvent selected from the group consisting of n-pentane, i-pentane, cyclopentane, n-hexane, i-hexane, cyclohexane, methylcyclohexane, n-heptane, i-heptane, n-octane, i-octane and hexamethylsiloxane.

9. The protective agent for printed matters printed with water-based ink according to claim 3, wherein the low-boiling hydrocarbon solvent is at least one kind of solvent selected from the group consisting of n-pentane, i-pentane, cyclopentane, n-hexane, i-hexane, cyclohexane, methylcyclohexane, n-heptane, i-heptane, n-octane, i-octane and hexamethylsiloxane.

10. The protective agent for printed matters printed with water-based ink according to claim to 2, wherein the oleophilic resin is at least one kind of resin selected from the group consisting of acrylic ester copolymer resins, silicone-acrylic resins, methyl phenyl silicone resins, 1,2-polybutadiene elastomers, polyisobutylene rubbers, aromatic petroleum resins, alicyclic petroleum resins and polystyrene resins.

11. The protective agent for printed matters printed with water-based ink according to claim 3, wherein the oleophilic resin is at least one kind of resin selected from the group consisting of acrylic ester copolymer resins, silicone-acrylic resins, methyl phenyl silicone resins, 1,2-polybutadiene elastomers, polyisobutylene rubbers, aromatic petroleum resins, alicyclic petroleum resins and polystyrene resins.

12. The protective agent for printed matters printed with water-based ink according to claim 4, wherein the oleophilic resin is at least one kind of resin selected from the group consisting of acrylic ester copolymer resins, silicone-acrylic resins, methyl phenyl silicone resins, 1,2-polybutadiene elastomers, polyisobutylene rubbers, aromatic petroleum resins, alicyclic petroleum resins and polystyrene resins.

13. A protective aerosol agent for printed matters printed with water-based ink comprising: 20 to 80 parts by weight of the protective agent for printed matters printed with water-based ink as set forth in claim 2 and 80 to 20 parts by weight of a propellant.

14. A protective aerosol agent for printed matters printed with water-based ink comprising: 20 to 80 parts by weight of the protective agent for printed matters printed with water-based ink as set forth in claim 3 and 80 to 20 parts by weight of a propellant.

15. A protective aerosol agent for printed matters printed with water-based ink comprising: 20 to 80 parts by weight of the protective agent for printed matters printed with water-based ink as set forth in claim 4 and 80 to 20 parts by weight of a propellant.

16. A protective aerosol agent for printed matters printed with water-based ink comprising: 20 to 80 parts by weight of the protective agent for printed matters printed with water-based ink as set forth in claim 5 and 80 to 20 parts by weight of a propellant.
